(19) United States
(12) Patent Application Publication
(10) Pub. No.: US 2026/0288659 A1
(43) Pub. Date: Sep. 24, 2026

(54) DDR FREQUENCY MANAGEMENT IN CHIPLET-BASED SYSTEM

(71) Applicant: QUALCOMM Incorporated, San Diego, CA (US)

(72) Inventors: Zhurang ZHAO, San Diego, CA (US); Joshua STUBBS, Longmont, CO (US); Andrew TORCHALSKI, Longmont, CO (US); Jerry YANG, San Diego, CA (US)

(21) Appl. No.: 19/088,805

(22) Filed: Mar. 24, 2025

(51) Int. Cl. G06F 13/16; G06F 1/08; G06F 13/40

(52) U.S. Cl. CPC G06F 13/1689; G06F 1/08; G06F 13/4068

(57) ABSTRACT

A chiplet-based system includes a primary chiplet die, a secondary chiplet die, a first memory, and a second memory. The primary chiplet die and the secondary chiplet die include a plurality of clients configured to access the memory according to a unified memory map, which each client accessing the memory according to corresponding bandwidth. The primary chiplet die includes an aggregation entity that is independent from an operating system for the chiplet-based system and that is configured to aggregate the bandwidth from the clients to form an aggregated bandwidth. The aggregation entity is also configured to determine a clocking frequency for the first memory and for the second memory that satisfies the aggregated bandwidth.

### TECHNICAL FIELD

The present application relates generally to chiplets, and more particularly to a chiplet-based system with DDR frequency management.

### BACKGROUND

Portable computing devices (“PCDs”) are becoming necessities for people on personal and professional levels. These devices may include cellular telephones, portable digital assistants (“PDAs”), portable game consoles, palmtop computers, and other portable electronic devices. PCDs typically have complex and compact electronic packaging that is generally made of multiple processing units that include central processing units, digital signal processors, and the like. Much of this hardware may be part of a system on a chip (“SOC”) design as understood by one of ordinary skill in the art.

An individual element in an SOC may be better suited for a particular semiconductor processing node as compared to the remaining elements. Integrating all the elements into a single integrated circuit thus involves a compromise with respect to its process node. The heterogenous integration of individual chiplets allows the process node and materials for each chiplet to be individually optimized for improved performance and cost. In addition, an individual chiplet in the system may be redesigned without requiring redesign of the remaining chiplets. The use of chiplets also avoids the SOC need for a relatively large die size that may result in lower yields.

The chiplets in a chiplet-based system typically require access to a dual-data rate (DDR) memory such as a DDR dynamic random-access memory (DRAM) or a DDR synchronous dynamic random-access memory (SDRAM). In a non-uniform memory architecture, each chiplet may manage its access to a local DDR memory. Although latency is thus reduced, such non-uniform memory architecture typically results in software challenges. In contrast, the software programming is eased if the various memories across the chiplets are treated as a single address space for both data and instruction in what is denoted as a uniform memory map.

### SUMMARY

In accordance with an aspect of the disclosure, a chiplet-based system is provided that includes: a first memory; a second memory; a primary chiplet die including: an at least one first memory client configured to access the first memory and the second memory through a unified memory map, wherein each at least one first memory client is further configured to access the first memory and the second memory according to a bandwidth; a first memory controller; and a first transition entity configured to command the first memory controller to transition an operating frequency of the first memory to a new frequency; a secondary chiplet die including: an at least one second memory client configured to access the first memory and the second memory through the unified memory map, wherein each at least one second memory client is further configured to access the first memory and the second memory according to a bandwidth; a second memory controller; and a second transition entity configured to command the second memory controller to transition an operating frequency of the second memory to the new frequency, wherein the primary chiplet die further includes: an aggregation entity configured to aggregate the bandwidth from each first memory client and from each second memory client to form an aggregated bandwidth and to determine the new frequency responsive to the aggregated bandwidth.

In accordance with another aspect of the disclosure, a method for a chiplet-based system is provided that includes: accessing a first memory and a second memory through a unified memory mapping for an at least one first client in a primary chiplet die and for an at least one second client in a secondary chiplet die, wherein each at least one first client and each at least one second client accesses the first memory and the second memory according to a corresponding bandwidth; aggregating the corresponding bandwidth from each at least one first client and from each at least one second client to form an aggregated bandwidth; determining a memory clocking frequency that satisfies the aggregated bandwidth; and transitioning the first memory and the second memory to both operate according to the memory clocking frequency.

Finally, in accordance with yet another aspect of the disclosure, a chiplet-based system is provided that includes: a first memory; a second memory; a primary chiplet die and a secondary chiplet die configured to implement an at least one processor that operates according to an operating system and configured to access the first memory and the second memory through a unified memory mapping, wherein the primary chiplet die includes: an at least one first client implemented by the operating system and configured to access the first memory and the second memory through the unified memory mapping; a first memory controller; an aggregation entity configured to aggregate a memory access bandwidth for the at least one first client in the primary chiplet die and a memory access bandwidth for an at least one second client in the secondary chiplet die to form an aggregated bandwidth and configured to determine a memory clocking frequency for the first memory and the second memory that satisfies the aggregated bandwidth; and a first transition entity configured to control the first memory controller to transition the first memory to the memory clocking frequency.

These and other advantageous features may be better appreciated through the following detailed description.

### BRIEF DESCRIPTION OF THE DRAWINGS

FIG. 1 illustrates a chiplet-based system in accordance with an aspect of the disclosure.

FIG. 2 illustrates a flowchart of an example of a method performed by the chiplet-based system in accordance with an aspect of the disclosure.

FIG. 3 illustrates an example computer system implemented by a chiplet-based system in accordance with an aspect of the disclosure.

FIG. 4 is a flowchart for an example method of managing clocking frequencies for DDR memories in a chiplet-based system in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

In a chiplet-based system with a uniform memory map, the DDR memories in the various chiplets are transparent to the operating system software. But this transparency raises an issue with respect to the DDR frequency management across the chiplets because the operating system software is not aware of the individual DDR frequencies. A chiplet-based system is disclosed herein with an advantageous DDR frequency management that is independent from the operating system software. Each chiplet includes at least one memory client that accesses the DDR memories through a unified memory map and according to a corresponding data rate. Since data rates and bandwidths are equivalent, the following discussion will refer to the memory client's bandwidth in lieu of the memory access data rate. Similarly, the following discussion will assume that each DDR memory is a DDR DRAM, but it will be appreciated that other types of DDR memories may be included in alternative implementations. Each chiplet also includes a memory controller that controls a clocking frequency of a corresponding DDR memory. The higher the memory clocking frequency, the greater is the number of read or write operations that the DDR DRAM may perform in a given unit of time. The memory clocking frequency is typically not fixed but instead may be increased for greater memory operating speed during periods of increased memory access demand or decreased for lower memory operating speed during periods of reduced memory access demand. The faster a DDR DRAM is clocked, the greater is the power consumption. The memory clocking frequency may thus be reduced for modes in which a memory client does not require high-speed operation to lower the power consumption.

But these different operating modes raise an issue in the DDR frequency management in a chiplet-based system because the various chiplets may be in different operating modes and thus desire changing DDR frequencies. But with a uniform memory map, the various DRAMs are transparent to the operating system software such that the operating system software does not know the memory configurations for the various DRAMs. A chiplet-based system is disclosed in which DDR-frequency managers advantageously manage the DDR frequencies for the DDR DRAMs so that the memory clients may access the DDR DRAMs through the uniform memory map without a need for the operating system software to manage or even be aware of the DRAM configurations.

In the following examples, the chiplet-based system will be assumed to employ an ARM-based architecture such that each chiplet may incorporate one or more memory clients such as a central processing unit (CPU), a graphic processing unit (GPU), a digital signal processor (DSP) and so on that function as virtual machines. But it will be appreciated that any suitable computer architecture may be used to implement the chiplet-based systems disclosed herein. In an ARM architecture, a hypervisor manages the memory clients'access to the physical resources of the chiplet-based system such as memory, storage, and processing power. As used herein, the term “DDR-frequency manager” is understood to be distinct from the operating system software such as the software running the memory clients/virtual machines and the hypervisor. For example, a DDR-frequency manager as disclosed herein may be a hardware sequencer that executes instructions that are not part of the software for the operating system of the chiplet-based system. Alternatively, a DDR-frequency manager may be implemented through an embedded micro-controller that runs firmware independent of the software for the operating system. In other implementations, the DDR-frequency manager may be implemented through a hardware-based state machine. The operating system software for the memory clients is thus advantageously agnostic with respect to the DDR frequency management.

Each chiplet in the chiplet-based system includes a memory controller that controls one or more corresponding DDR DRAMs. The memory clients in the chiplets access the DDR memories as one entity through a unified memory map. For example, the DDR DRAMs may be fully interleaved through the unified memory map. The chiplet-based system discussed in the present disclosure utilizes DDR-frequency-managing entity that functions as a DDR frequency manager to scale the DDR frequency across the chiplets in parallel in a controlled fashion such that there is no need to involve the operating system software in the management of the DDR frequency in each chiplet. This approach allows for DDR frequency across multiple chiplets without having software overhead and enables DDR memory interleaving and a unified memory map without the operating system software overhead. Each chiplets's DDR frequency manager commands the chiplet's memory controller to switch the DDR frequency in parallel with the other chiplets to shorten an overall latency of the system.

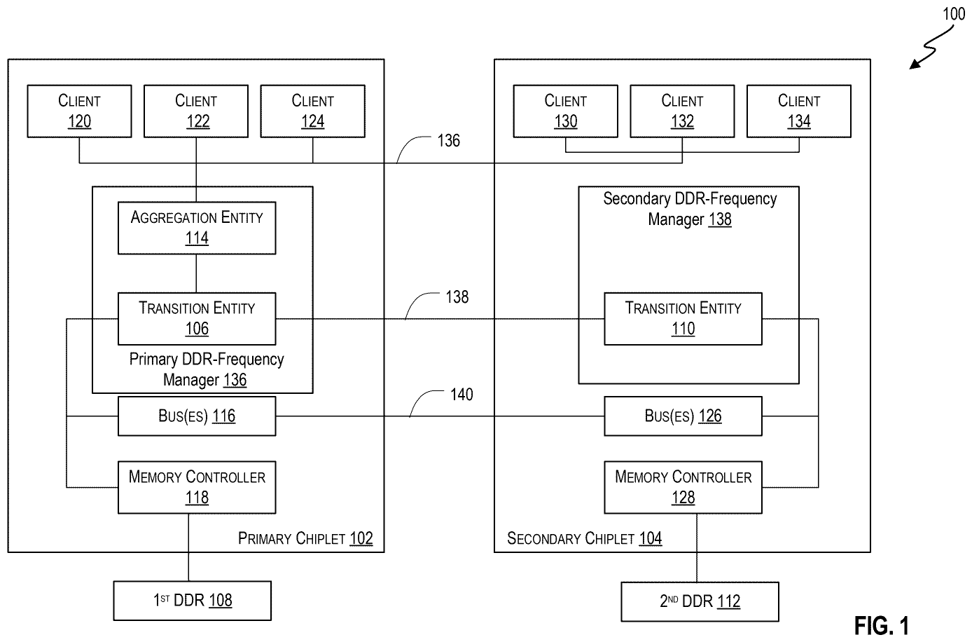

An example chiplet-based system 100 is shown in FIG. 1. The chiplet-based system 100 may include a primary chiplet 102 and one or more secondary chiplets 104. For illustration clarity, just one secondary chiplet 104 is shown in FIG. 1 but it will be appreciated that a plurality of secondary chiplets 104 may be included in alternative implementations. The primary chiplet 102 includes a primary DDR-frequency manager 136 having a first transition entity 106 configured to command or control a memory controller 118 for the primary chiplet 102 to transition a DDR frequency of a first DDR DRAM 108 to a memory clocking frequency. For brevity, the first DDR DRAM 108 is also denoted herein as a DDR 108. Similarly, each secondary chiplet 104 may include a secondary DDR-frequency manager 138 having a second transition entity 110 configured to command a memory controller 128 for the secondary chiplet 104 to transition a second DDR memory 112 to the memory clocking frequency. For brevity, the second DDR DRAM 112 is also denoted herein as a DDR 112.

The primary chiplet 102 includes a plurality of first memory clients such as a memory client 120, a memory client 122, and a memory client 124. The memory clients 120, 122, 124 may each comprise a CPU, a GPU a DSP, or a hardware entity that each accesses (reads to and writes from) the DDRs 108 and 112. The memory clients 120, 122, and 124 couple through a bus (or buses) 116 to the memory controller 118 to access the DDRs 108 and 112. Similarly, the secondary chiplet 102 includes a plurality of memory clients such as a memory client 130, a memory client 132, and a memory client 134 that couple through a bus (or buses) 126 to the memory controller 128 to access the DDRs 108 and 112. Due to the unified memory mapping and the associated address interleaving of the DDRs 108 and 118, these memories appear as a single memory to the memory clients 120, 122, 124, 130, 132, and 134. A symbolic signal path 140 represents the address interleaving of the DDRs 108 and 112 to the memory clients.

Depending upon their mode of operation, each of the memory clients requires a corresponding amount of bandwidth (or equivalently, a corresponding data communication speed) with respect to accessing the DDRs 108 and 112 through read and write operations. The primary DDR manager 136 thus includes an aggregation entity that aggregates the bandwidths of the various memory clients as communicated over a signal path 136. For example, suppose that the memory client 130 requests for a 100-megabyte (MB) bandwidth whereas the memory client 120 requests for a 50 MB bandwidth. Assuming that the other memory clients do not require any bandwidth due to, e.g., being in an idle or sleep mode, the aggregation entity 114 aggregates the 100 MB with the 50 MB. Should the aggregation be a summation, the resulting aggregation forms a total bandwidth of 150 MB. Based upon this aggregated bandwidth, the first transition entity 106 determines a memory clocking frequency so that when the DDRs 108 and 112 are clocked according to the memory clocking frequency, the memory clients can access the DDRs 108 and 112 according to the total bandwidth. The first transition entity 106 coordinates with the second transition entity 110 to command their respective memory controllers 118 and 128 to transition the DDRs 108 and 112 to the memory clocking frequency that supports the aggregated bandwidth. This coordination between the transition entities 106 and 110 is represented symbolically in FIG. 1 by a signal path 138.

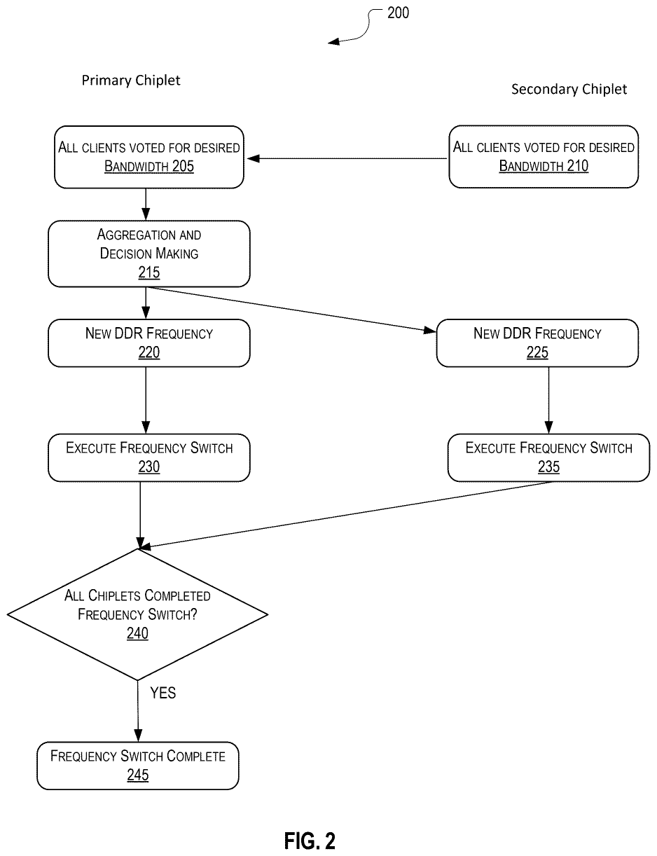

More generally, each memory client may be deemed to vote for a bandwidth. Should a memory client be idle, the desired bandwidth may be zero or minimal whereas more bandwidth will be desired should a memory client be active. The first aggregation entity 114 then aggregates the “votes” (in this case, the desired bandwidth) from each memory client to form the aggregated bandwidth that equals (in some implementations) the sum of the bandwidths voted for by the memory clients. Alternatively, the aggregation may be based upon an average of the desired bandwidths or a maximum value of the desired bandwidths. Note that the desired bandwidth from a memory client may be differentiated into (for example) an instantaneous bandwidth and an average bandwidth. The aggregation in some implementations may thus be based upon the larger of a maximum of the instantaneous bandwidths and a sum of the average bandwidths. A resulting process flow 200 for the chiplet-based system 100 is shown in FIG. 2. In a step 205, all the memory clients in the primary chiplet die have voted for their desired bandwidth. At the same time, all the memory client in the secondary chiplet die vote for their desired bandwidth in a step 210. The desired bandwidths are aggregated in a step 215 so that a determination may be made of the corresponding memory clocking frequency that will support the aggregated bandwidth. In a step 220, the primary chiplet die determines the memory clocking frequency based upon the aggregated bandwidth and also transmits the memory clocking frequency to the secondary chiplet die in a step 225. The memory controller in the primary chiplet executes the DDR frequency switch to the new DDR frequency in a step 230 while the memory controller in the secondary chiplet also executes the DDR frequency switch to the new DDR frequency in a step 235. The primary DDR manager then ensures that the all the chiplets have performed the DDR frequency switch in a step 240 such that the DDR frequency switch is complete in a step 245. At this point, the primary DDR manager may inform the operating system software and/or the requesting memory clients that a DDR frequency transition has been completed. Although the DDR frequency switch is conveniently performed herein with respect to desired bandwidths for the memory clients, it will be appreciated that the clients may instead vote directly for a DDR frequency in alternative implementations.

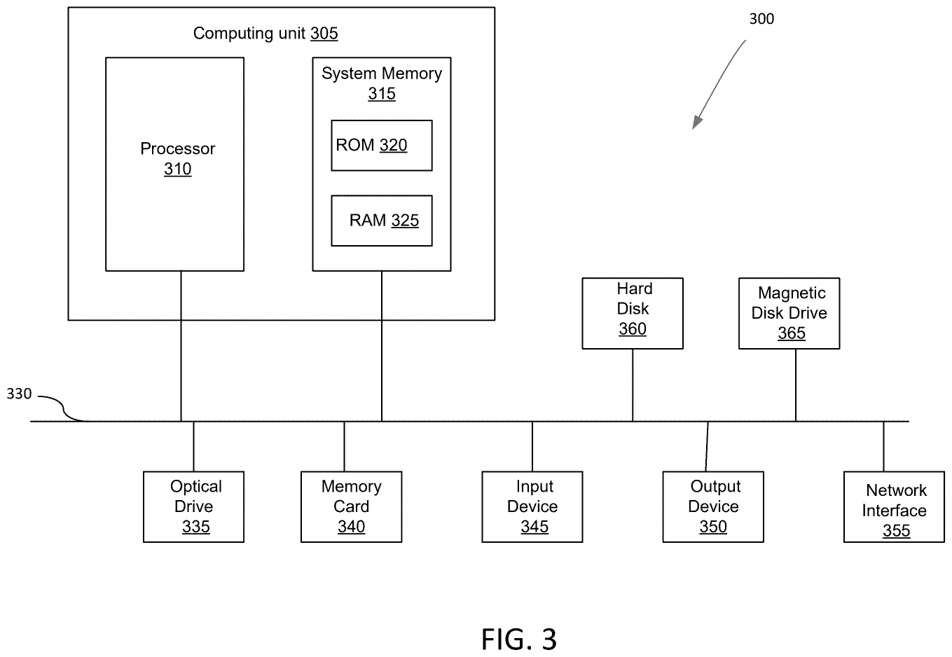

The chiplet-based systems disclosed herein are configured to implement a computer system that includes one or more processors that implement the operating system software. An example chiplet-based computing system 300 is shown in FIG. 3. As seen in this figure, the computing system 300 includes a computing unit 305 with an at least one processor 310 that executes instructions for the operating system software and stores data in a system memory 315. The at least one processor 310 may be any type of programmable electronic device for executing software instructions but will typically be one or more microprocessors. The system memory 315 may include both a read-only memory (ROM) 320 and a random-access memory (RAM) 325. As will be appreciated by those of ordinary skill in the art, both the read-only memory (ROM) 320 and the random-access memory (RAM) 325 may store software instructions for execution by the at least one processor 310.

The at least one processor 310 and the system memory 315 are connected, either directly or indirectly, through a bus 330 or alternate communication structure, to one or more peripheral devices. For example, the at least one processor 310 or the system memory 315 may be directly or indirectly connected to one or more additional memory storage devices, such as a “hard” magnetic disk drive 360, a removable magnetic disk drive 365, an optical disk drive 335, or a flash memory card 340. The at least one processor 310 and the system memory 315 also may be directly or indirectly connected to one or more input devices 345 and one or more output devices 350. The input devices 345 may include, for example, a keyboard, a pointing device (such as a mouse, touchpad, stylus, trackball, or joystick), a scanner, a camera, and a microphone. The output devices 345 may include, for example, a monitor display, a printer and speakers. With various examples of the computer system 300, one or more of the peripheral devices 335, 340, 345, 350, 360, and 365 may be internally housed within a housing of the computer system 300. Alternately, one or more of the peripheral devices 335, 340, 345, 350, 360, and 365 may be external to the housing and connected to the bus 330 through, for example, a Universal Serial Bus (USB) connection.

With some implementations, the computing system 300 may be directly or indirectly connected to one or more network interfaces 355 for communicating with other devices making up a network. The network interface 355 translates data and control signals from the computer system 300 into network messages according to one or more communication protocols, such as the transmission control protocol (TCP) and the Internet protocol (IP). Also, the interface 355 may employ any suitable connection agent (or combination of agents) for connecting to a network, including, for example, a wireless transceiver, a modem, or an Ethernet connection. Such network interfaces and protocols are well known in the art, and thus will not be discussed here in more detail. It should be appreciated that the computing system 300 is illustrated as an example only, and it not intended to be limiting. Various implementations may be formed using one or more computing systems that include the components of the system 300 illustrated in FIG. 3 or which include only a subset of the components illustrated in FIG. 3, or which include an alternate combination of components, including components that are not shown in FIG. 3.

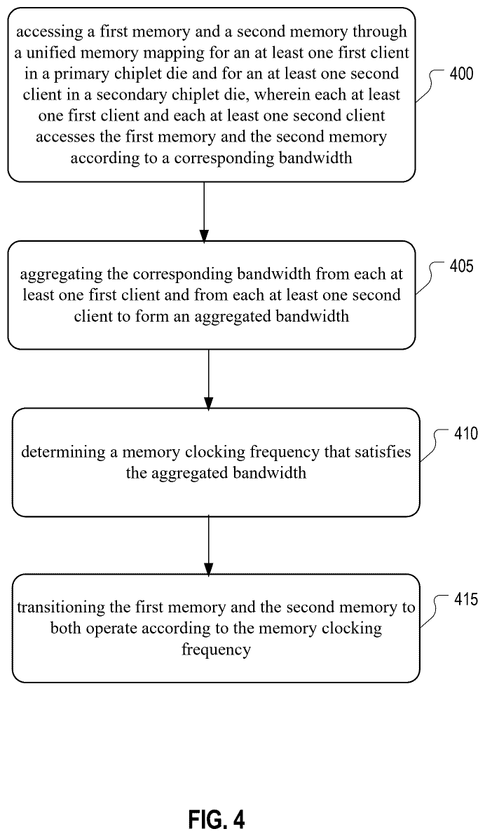

A flowchart for a method of managing the DDR frequencies in a chiplet-based system is shown in FIG. 4. The method includes an act 400 of accessing a first memory and a second memory through a unified memory mapping for an at least one first client in a primary chiplet die and for an at least one second client in a secondary chiplet die, wherein each at least one first client and each at least one second client accesses the first memory and the second memory according to a corresponding bandwidth. The access to the memories 108 and 112 by the memory clients 120, 122, 124, 130, 132, and 134 in the chiplet-based system 100 is an example of act 400. The method also includes an act 405 of aggregating the corresponding bandwidth from each at least one first client and from each at least one second client to form an aggregated bandwidth. The aggregation of the bandwidths by the first aggregation entity 114 is an example of act 405. The method further includes an act 410 of determining a memory clocking frequency that satisfies the aggregated bandwidth. The memory clocking frequency determination by the first aggregation entity 114 is an example of act 410. Finally, the method includes an act 415 of transitioning the first memory and the second memory to both operate according to the memory clocking frequency. The transitioning of the DDRs 108 and 112 as commanded by the corresponding transition entities 106 and 110 is an example of act 415.

Some example implementations will now be summarized through the following numbered clauses:

Clause 1. A chiplet-based system, comprising:
a first memory;
a second memory;
a primary chiplet die including:
an at least one first memory client configured to access the first memory and the second memory through a unified memory map, wherein each at least one first memory client is further configured to access the first memory and the second memory according to a bandwidth;
a first memory controller; and
a first transition entity configured to command the first memory controller to transition the first memory to a memory clocking frequency;
a secondary chiplet die including:
an at least one second memory client configured to access the first memory and the second memory through the unified memory map, wherein each at least one second memory client is further configured to access the first memory and the second memory according to a bandwidth;
a second memory controller; and
a second transition entity configured to command the second memory controller to transition the second memory to the memory clocking frequency, wherein the primary chiplet die further includes:
an aggregation entity configured to aggregate the bandwidth from each first memory client and from each second memory client to form an aggregated bandwidth and to determine the memory clocking frequency responsive to the aggregated bandwidth.

Clause 2. The chiplet-based system of clause 1, wherein the first memory comprises a first double data rate (DDR) memory and wherein the second memory comprises a second DDR memory.

Clause 3. The chiplet-based system of clause 2, wherein the first DDR memory and the second DDR memory each comprises a DDR dynamic random-access memory.

Clause 4. The chiplet-based system of any of clauses 1-3, wherein the first transition entity is further configured to coordinate with the second transition entity so that the first memory and the second memory both transition to the memory clocking frequency in parallel.

Clause 5. The chiplet-based system of any of clauses 1-4, wherein the first transition entity, the second transition entity, and the aggregation entity are independent from an operating system for the chiplet-based system.

Clause 6. The chiplet-based system of clause 5, wherein the aggregation entity is further configured to inform the operating system that a transition by the first memory and by the second memory to the memory clocking frequency is completed.

Clause 7. The chiplet-based system of any of clauses 1-6, wherein the aggregation entity, the first transition entity, and the second transition entity each comprises a hardware sequencer.

Clause 8. The chiplet-based system of any of clauses 1-6, wherein the aggregation entity, the first transition entity, and the second transition entity each comprises a state machine.

Clause 9. The chiplet-based system of any of clauses 1-6, wherein the aggregation entity, the first transition entity, and the second transition entity each comprises an embedded micro-controller.

Clause 10. The chiplet-based system of any of clauses 1-9, further comprising:
an at least one bus coupled between the primary chiplet die and the secondary chiplet die.

Clause 11. A method of operation for a chiplet-based system, comprising:
accessing a first memory and a second memory through a unified memory mapping for an at least one first client in a primary chiplet die and for an at least one second client in a secondary chiplet die, wherein each at least one first client and each at least one second client accesses the first memory and the second memory according to a corresponding bandwidth;
aggregating the corresponding bandwidth from each at least one first client and from each at least one second client to form an aggregated bandwidth;
determining a memory clocking frequency that satisfies the aggregated bandwidth; and
transitioning the first memory and the second memory to both operate according to the memory clocking frequency.

Clause 12. The method of clause 11, further comprising:
implementing the at least one first client using instructions for an operating system for the chiplet-based system, wherein aggregating the corresponding bandwidth, determining the memory clocking frequency, and transitioning the first memory and the second memory are independent from the operating system.

Clause 13. The method of any of clauses 11-12, wherein the transitioning of the first memory to operate according to the memory clocking frequency occurs in parallel with the transitioning of the second memory to operate according to the memory clocking frequency.

Clause 14. The method of any of clauses 11-13, wherein the transitioning of the first memory comprises transitioning a first double data rate dynamic random-access memory to operate according to the memory clocking frequency, and wherein the transitioning of the second memory comprises transitioning a second double data rate dynamic random-access memory to operate according to the memory clocking frequency.

Clause 15. The method of any of clauses 11-14, wherein the aggregating of the corresponding bandwidth from each at least one first client and from each at least one second client comprises summing the corresponding bandwidth from each at least one first client and from each at least one second client.

### Clause 16. a Chiplet-based System, Comprising:

a first memory;
a second memory;
a primary chiplet die and a secondary chiplet die configured to implement an at least one processor that operates according to an operating system and configured to access the first memory and the second memory through a unified memory mapping, wherein the primary chiplet die includes:
an at least one first client implemented by the operating system and configured to access the first memory and the second memory through the unified memory mapping;
a first memory controller;
an aggregation entity configured to aggregate a memory access bandwidth for the at least one first client in the primary chiplet die and a memory access bandwidth for an at least one second client in the secondary chiplet die to form an aggregated bandwidth and configured to determine a memory clocking frequency for the first memory and the second memory that satisfies the aggregated bandwidth; and
a first transition entity configured to command the first memory controller to transition the first memory to the memory clocking frequency.

Clause 17. The chiplet-based system of clause 16, wherein the secondary chiplet die includes:
a second memory controller; and
a second transition entity configured to command the second memory controller to transition the second memory to the memory clocking frequency.

Clause 18. The chiplet-based system of any of clauses 16-17, wherein the first memory and the second memory each comprises a DDR DRAM.

Clause 19. The chiplet-based system of any of clauses 16-18, wherein the aggregation entity and the first transition entity are independent from the operating system.

Clause 20. The chiplet-based system of any of clauses 16-19, wherein the first memory and the second memory are fully interleaved.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A chiplet-based system, comprising:
a first memory;
a second memory;
a primary chiplet die including:
an at least one first memory client configured to access the first memory and the second memory through a unified memory map, wherein each at least one first memory client is further configured to access the first memory and the second memory according to a bandwidth;
a first memory controller; and
a first transition entity configured to command the first memory controller to transition the first memory to a memory clocking frequency;
a secondary chiplet die including:
an at least one second memory client configured to access the first memory and the second memory through the unified memory map, wherein each at least one second memory client is further configured to access the first memory and the second memory according to a bandwidth;
a second memory controller; and
a second transition entity configured to command the second memory controller to transition the second memory to the memory clocking frequency, wherein the primary chiplet die further includes:
an aggregation entity configured to aggregate the bandwidth from each first memory client and from each second memory client to form an aggregated bandwidth and to determine the memory clocking frequency responsive to the aggregated bandwidth.

2. The chiplet-based system of claim 1, wherein the first memory comprises a first double data rate (DDR) memory and wherein the second memory comprises a second DDR memory.

3. The chiplet-based system of claim 2, wherein the first DDR memory and the second DDR memory each comprises a DDR dynamic random-access memory.

4. The chiplet-based system of claim 1, wherein the first transition entity is further configured to coordinate with the second transition entity so that the first memory and the second memory both transition to the memory clocking frequency in parallel.

5. The chiplet-based system of claim 1, wherein the first transition entity, the second transition entity, and the aggregation entity are independent from an operating system for the chiplet-based system.

6. The chiplet-based system of claim 5, wherein the aggregation entity is further configured to inform the operating system that a transition by the first memory and by the second memory to the memory clocking frequency is completed.

7. The chiplet-based system of claim 1, wherein the aggregation entity, the first transition entity, and the second transition entity each comprises a hardware sequencer.

8. The chiplet-based system of claim 1, wherein the aggregation entity, the first transition entity, and the second transition entity each comprises a state machine.

9. The chiplet-based system of claim 1, wherein the aggregation entity, the first transition entity, and the second transition entity each comprises an embedded micro-controller.

10. The chiplet-based system of claim 1, further comprising:
an at least one bus coupled between the primary chiplet die and the secondary chiplet die.

11. A method of operation for a chiplet-based system, comprising:
accessing a first memory and a second memory through a unified memory mapping for an at least one first client in a primary chiplet die and for an at least one second client in a secondary chiplet die, wherein each at least one first client and each at least one second client accesses the first memory and the second memory according to a corresponding bandwidth;
aggregating the corresponding bandwidth from each at least one first client and from each at least one second client to form an aggregated bandwidth;
determining a memory clocking frequency that satisfies the aggregated bandwidth; and
transitioning the first memory and the second memory to both operate according to the memory clocking frequency.

12. The method of claim 11, further comprising:
implementing the at least one first client using instructions for an operating system for the chiplet-based system, wherein aggregating the corresponding bandwidth, determining the memory clocking frequency, and transitioning the first memory and the second memory are independent from the operating system.

13. The method of claim 11, wherein the transitioning of the first memory to operate according to the memory clocking frequency occurs in parallel with the transitioning of the second memory to operate according to the memory clocking frequency.

14. The method of claim 11, wherein the transitioning of the first memory comprises transitioning a first double data rate dynamic random-access memory to operate according to the memory clocking frequency, and wherein the transitioning of the second memory comprises transitioning a second double data rate dynamic random-access memory to operate according to the memory clocking frequency.

15. The method of claim 11, wherein the aggregating of the corresponding bandwidth from each at least one first client and from each at least one second client comprises summing the corresponding bandwidth from each at least one first client and from each at least one second client.

16. A chiplet-based system, comprising:
a first memory;
a second memory;
a primary chiplet die and a secondary chiplet die configured to implement an at least one processor that operates according to an operating system and configured to access the first memory and the second memory through a unified memory mapping, wherein the primary chiplet die includes:
an at least one first client implemented by the operating system and configured to access the first memory and the second memory through the unified memory mapping;
a first memory controller;
an aggregation entity configured to aggregate a memory access bandwidth for the at least one first client in the primary chiplet die and a memory access bandwidth for an at least one second client in the secondary chiplet die to form an aggregated bandwidth and configured to determine a memory clocking frequency for the first memory and the second memory that satisfies the aggregated bandwidth; and
a first transition entity configured to command the first memory controller to transition the first memory to the memory clocking frequency.

17. The chiplet-based system of claim 16, wherein the secondary chiplet die includes:
a second memory controller; and
a second transition entity configured to command the second memory controller to transition the second memory to the memory clocking frequency.

18. The chiplet-based system of claim 16, wherein the first memory and the second memory each comprises a DDR DRAM.

19. The chiplet-based system of claim 16, wherein the aggregation entity and the first transition entity are independent from the operating system.

20. The chiplet-based system of claim 16, wherein the first memory and the second memory are fully interleaved.
